(19) United States
(12) Patent Application Publication
(10) Pub. No.: US 2009/0109204 A1
(43) Pub. Date: Apr. 30, 2009

(54) ELECTRO-OPTICAL DEVICE AND ELECTRONIC APPARATUS

(75) Inventor: Toru AOKI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/260,227

(22) Filed: Oct. 29, 2008

(30) Foreign Application Priority Data
Oct. 30, 2007 (JP) 2007-281391

(51) Int. Cl. G06F 3/038

(52) U.S. Cl. 345/211

(57) ABSTRACT

An electro-optical device includes a compensation device that applies a voltage to a data line over a compensation period from a first timing to a second timing in order to compensate for a decrease in electric potential of the data line that occurs at the first timing. The first timing is when the sampling switch is switched from a conductive state to a non-conductive state during a first horizontal scanning period. The second timing is when the sampling switch is switched from the non-conductive state to the conductive state during a second horizontal scanning period that comes following the first horizontal scanning period.

### BACKGROUND

1. Technical Field

The present invention relates to a technical field of an electro-optical device, such as a liquid crystal device that is driven through an inversion driving method, and an electronic apparatus, such as a projector, provided with the electro-optical device.

2. Related Art

A liquid crystal device, which is an example of an electro-optical device of this type, employs an inversion driving method in which the polarity of a voltage applied to each pixel electrode is inverted in accordance with a predetermined rule in order to prevent burn-in and degradation of liquid crystal. Among inversion driving methods, a 1H inversion driving method in which the polarity of an image signal supplied to a pixel electrode is inverted to positive polarity or negative polarity with respect to a predetermined electric potential every one horizontal scanning period is used as an inversion driving method that enables relatively easy control and high-quality image display.

When pixel switching TFTs provided respectively in a plurality of pixel portions that constitute a display area of the liquid crystal device are switched from an on state to an off state, a decrease in electric potential of each pixel electrode (so-called push-down phenomenon) occurs because of the capacitance between the gate and source of each TFT. When the above decrease in electric potential occurs, the electric potential of each pixel electrode is not set symmetrically with respect to a reference electric potential in accordance with respective positive polarity and negative polarity electric potentials. As a direct-current voltage is applied to the liquid crystal due to the asymmetric effective voltage values, the liquid crystal problematically degrades because of burn-in, or the like.

JP-A-2002-182622 suggests an image signal correction circuit, or the like, that compensates for a decrease in electric potential of each pixel electrode, which occurs due to operation of the corresponding pixel switching TFT.

However, the size of a semiconductor device, such as TFT, mounted on the electro-optical device as a sampling switch that samples an image signal is generally larger than the size of a pixel switching TFT. Thus, because a decrease in electric potential, which occurs in a data line when the sampling switch is switched from an on state (that is, conductive state) to an off state (that is, a non-conductive state), is larger than a decrease in electric potential of a pixel electrode in accordance with operation of a pixel switching TFT, the major part of the decrease in electric potential of each pixel electrode is caused by the operation of the sampling switch. A decrease in electric potential of a data line, which occurs in accordance with operation of the sampling switch, more specifically, a decrease in electric potential of a pixel electrode, which occurs in response to a decrease in electric potential of the data line, dominantly causes defective display.

Particularly, in an electro-optical device, such as a liquid crystal device, that employs an inversion driving method in which image signals having inverted polarities with respect to a reference electric potential are supplied every a horizontal scanning period, in order to compensate for a decrease in electric potential of a data line, which occurs due to operation of the sampling switch, more specifically, a decrease in electric potential of a pixel electrode, which occurs in response to the decrease in electric potential of the data line, it requires a process to, for example, shift the reference electric potential to a low electric potential side in advance or set the electric potential of a positive polarity image signal to a high electric potential side in advance. This problematically results in a complex circuitry of circuit portions that supply image signals.

In addition, when effective voltage values applied to the liquid crystal, that is, voltages applied between a pixel electrode and an opposite electrode that faces the pixel electrode, are asymmetric due to the operation of the sampling switch, degradation of the liquid crystal easily occurs, leading to a problematic decrease in reliability of the liquid crystal device.

In addition, in accordance with characteristic variations of a plurality of sampling switches provided in correspondence with a plurality of data lines, a decrease in electric potential of each data line, which occurs due to operation of these sampling switches, varies. It is technically difficult to set the electric potential of an image signal sampled from each data line for each sampling switch in order to reduce the above variations.

### SUMMARY

An advantage of some aspects of the invention is that it provides an electro-optical device, such as a liquid crystal device, which employs an inversion driving method, that suppresses a decrease in electric potential of each pixel electrode by suppressing a decrease in electric potential of each data line, which occurs due to operation of the corresponding sampling switch, to thereby reduce defective display, and also provides an electronic apparatus, such as a projector, that employs the electro-optical device as a light valve.

An aspect of the invention provides an electro-optical device. The electro-optical device includes a substrate, a plurality of scanning lines, a plurality of data lines, a plurality of pixel electrodes, sampling switches, and a compensation device. The plurality of pixel electrodes are provided in a display area on the substrate at positions corresponding to intersections of the plurality of scanning lines and the plurality of data lines that intersect with each other. Each of the sampling switches is electrically connected to a corresponding one of the data lines, wherein each of the sampling switches samples an image signal by being supplied with a sampling signal, and supplies the sampled image signal to the corresponding data line. The compensation device compensates a decrease in electric potential of each data line, which occurs at a first timing, at which the corresponding sampling switch is switched from a conductive state to a non-conductive state during a first horizontal scanning period, over a compensation period from the first timing to a second timing, at which the corresponding sampling switch is switched from the non-conductive state to the conductive state during a second horizontal scanning period that comes following the first horizontal scanning period.

According to the electro-optical device of the aspect of the invention, for example, when the electro-optical device is a liquid crystal device, the plurality of pixel electrodes are provided in the display area at positions corresponding to intersections of the plurality of scanning lines and the plurality of the data lines. The above pixel electrodes are, for example, formed on the substrate as portions of pixel portions that include liquid crystal elements as display elements.

Each of the sampling switches is electrically connected to a corresponding one of the data lines, and, for example, samples an image signal supplied from an image signal supply circuit in accordance with a sampling signal to supply the sampled image signal to the corresponding data line. More specifically, for example, the sampling switch formed of a semiconductor device such as a TFT is provided on the substrate for each data line or each group of a plurality of data lines. The sampling switch is switched from a non-conductive state to a conductive state by being supplied with a sampling signal and then samples an image signal. The sampled image signal is supplied through the sampling switch to the data line corresponding to that sampling switch.

The compensation device compensates for a decrease in electric potential of each data line, which occurs at a first timing, at which the corresponding sampling switch is switched from a conductive state to a non-conductive state during a first horizontal scanning period, over a compensation period from the first timing to a second timing, at which the corresponding sampling switch is switched from the non-conductive state to the conductive state during a second horizontal scanning period that comes following the first horizontal scanning period.

Here, the first horizontal scanning period is, for example, a period during which a scanning signal is supplied to one row among the plurality of pixel portions that are arranged in a matrix, and the second horizontal scanning period is a period during which a scanning signal is supplied to a plurality of pixel portions that constitute the next row to the one row. That is, the first horizontal scanning period and the second horizontal scanning period are located adjacent to each other over time among a plurality of horizontal scanning periods that sequentially come in order to input image signals to the plurality of pixel portions.

The first timing is, for example, a timing at which a sampling signal is supplied to a sampling switch that is electrically connected to a selected one of the plurality of data lines that are electrically connected to the plurality of pixel portions, respectively, that constitute one row to which a scanning signal is supplied during the first horizontal scanning period. The second timing is a timing at which a sampling signal is supplied to the sampling switch that is electrically connected to the data line during the second horizontal scanning period. Each sampling switch, when the electro-optical device is operated, samples an image signal by being switched from a non-conductive state to a conductive state in accordance with a sampling signal during the first horizontal scanning period and the second horizontal scanning period, and then supplies the sampled image signal to the data line. During the first horizontal scanning period and the second horizontal scanning period, a scanning signal is sequentially supplied to scanning lines that are located adjacent to each other along the data line, an image signal is supplied to a pixel portion that constitutes a portion of one row during the first horizontal scanning period through the pixel switching TFT that is operated in switching in accordance with the scanning signal, and an image signal is supplied to a pixel portion that constitutes a portion of the next row to the one row during the second horizontal scanning period. Because the pixel portions that constitute portions of different rows, respectively, are electrically connected to the same data line, when the electric potential of the data line is decreased in such a manner that the corresponding sampling switch is switched from a conductive state to a non-conductive state at the first timing, the electric potential of an image signal that is supplied to the pixel portion during the second horizontal scanning period decreases in response to the decrease in electric potential of that data line. Thus, when an image signal is supplied to the pixel electrode of a pixel portion through the data line and the scanning line during the second horizontal scanning period without taking any measures, the pixel electrode electric potential will not be set with an electric potential that corresponds to the originally desired electric potential of the image signal. This causes defective display such as crosstalk.

Then, in the electro-optical device according to the aspect of the invention, the compensation device compensates a decrease in electric potential of each data line, which occurs due to operation of the sampling switch at the first timing, over a compensation period from the first timing to the second timing. By so doing, it is possible to supply an image signal, in which a decrease in electric potential due to operation of the sampling switch is not occurring, to each of the pixel portions that constitute portions of adjacent rows respectively at a predetermined timing during the first horizontal scanning period and the second horizontal scanning period, more specifically, at a timing at which the sampling switch is switched from a non-conductive state to a conductive state. This can suppress a decrease in electric potential of each pixel electrode, that is, can reduce defective display due to a push-down that occurs due to sampling operation.

Thus, owing to the compensation device, it is possible to compensate for a decrease in electric potential of each pixel electrode due to operation of the sampling switch, which occupies a major part of the decrease in electric potential and, therefore, it is not necessary to form a circuit for setting the electric potential of an image signal to a high electric potential side in advance. In addition, it is not necessary to set the electric potential of each image signal in accordance with characteristic variations of the sampling switch. Thus, according to the electro-optical device of the aspect of the invention, it is possible to avoid a complex circuitry of various circuit portions that drive the electro-optical device for reducing a push-down.

Specifically, when the liquid crystal device, which is an example of the electro-optical device according to the aspect of the invention, employs an inversion driving method, according to the electro-optical device of the aspect of the invention, it is possible to reduce the situation that the electric potential of each data line decreases in accordance with operation of the sampling switch and, therefore, the electric potential of each pixel electrode is set to be lower than the electric potential of a predetermined image signal in response to the decrease in electric potential of each data line. Thus, it is advantageously not necessary to perform processes, such as shifting the reference electric potential to a lower electric potential side in advance or setting the electric potential of a positive polarity image signal to a high electric potential side in advance, in order to compensate for a decrease in electric potential of each pixel electrode, which occurs in response to the decrease in electric potential of the corresponding data line.

In this way, according to the electro-optical device of the aspect of the invention, it is not only possible to suppress a complex circuitry of circuit portions that drive the electro-optical device but also possible to reduce defective display due to a push-down. In addition, in the electro-optical device, such as the liquid crystal device, that employs an inversion driving method, it is not only possible to reduce defective display but also possible to reduce degradation of the liquid crystal due to a direct-current voltage component that occurs due to asymmetric driving voltages applied to the liquid crystal. Thus, it is possible to improve reliability of the electro-optical device, such as the liquid crystal device.

In the electro-optical device according to the aspect of the invention, the compensation device may apply a voltage, which is larger than or equal to a compensation voltage that compensates for a decrease in the electric potential, to each data line over the corresponding compensation period.

According to the above aspect, for example, in the electro-optical device, such as the liquid crystal device, that employs an inversion driving method, by applying a voltage, which is larger than or equal to a compensation voltage that compensates for a decrease in electric potential, which occurs in each data line due to operation of the corresponding sampling switch at the first timing, to the data line over the compensation period, it is possible to reduce leakage current that leaks from each pixel switching TFT, which is an n-channel TFT. More specifically, because, for example, the source of each pixel switching TFT is electrically connected to the corresponding data line, by shifting the electric potential of the data line to a high electric potential side, the voltage between the gate and source of the pixel switching TFT becomes smaller than the threshold voltage of the TFT and, therefore, it is possible to reduce occurrence of leakage current.

In addition, according to the above aspect, in the electro-optical device, such as the liquid crystal device, that employs, for example, an inversion driving method, it is not necessary to set the electric potential of a positive polarity image signal to a high electric potential side in advance so as to compensate for a decrease in electric potential of the image signal. Thus, it is possible to suppress the source electric potential of the sampling switch being set to be high in accordance with the electric potential of a positive polarity image signal and, hence, it is possible to set the source electric potential to be low at the time of operation of the sampling switch.

Thus, according to the above aspect, for example, in comparison with the case in which a voltage larger than or equal to a compensation voltage is not applied to the data line at the time of operation of the sampling switch, which is a semiconductor device such as a TFT, because it is possible to apply a sampling signal having a relatively low electric potential to the gate of the sampling switch and a voltage larger than or equal to the threshold voltage of the sampling switch may be applied between the source and gate of the sampling switch, it is possible to improve the operating characteristic of the sampling switch.

In the electro-optical device according to the aspect of the invention, each sampling switch may be electrically connected to one end of the corresponding data line, and the compensation device may include a capacitive device that is electrically connected to the other end, opposite to the one end, of a corresponding one of the data lines and a compensation signal supply device that supplies a compensation signal to each capacitive device over the compensation period so that the capacitive device is able to compensate for a decrease in the electric potential.

According to the above aspect, by supplying the compensation signal to the capacitive device, it is possible to apply a data line with a voltage that compensates for a decrease in electric potential of the data line using electric charge that is generated in the corresponding capacitive device on the basis of the capacitance of the capacitive device and the voltage of the compensation signal. Note that the combination of the capacitance of the capacitive device and the voltage of the compensation signal may be set separately and specifically in accordance with the capacitance between the gate and source of the sampling switch. For example, when the voltage of the compensation signal cannot be set separately in accordance with a decrease in electric potential of the data line, or when the voltage of the compensation signal cannot be increased, by setting the capacitance of the capacitive element, such as a capacitor formed on the substrate as an example of the capacitive device, to an appropriate capacitance in advance, it is possible to compensate for a decrease in electric potential of the data line without separately changing the voltage of the compensation signal.

Particularly, in this aspect, the capacitance of the capacitive device is desirably equivalent to the capacitance between the gate and source of the corresponding sampling switch. According to the above capacitive device, even without changing the magnitude of the voltage of the compensation signal or setting the magnitude of the voltage to an appropriate value, it is possible to compensate for a decrease in electric potential of the data line using a change in electric potential, which occurs in accordance with the capacitance of the capacitive element.

In this aspect, the compensation signal may have an amplitude that is equivalent to that of the sampling signal.

According to the above aspect, for example, when the capacitance of the capacitive device is equal to the capacitance between the gate and source of the sampling switch, it is possible to apply a voltage corresponding to the decrease in electric potential of the data line from the corresponding capacitive device to the data line.

Another aspect of the invention provides an electronic apparatus that includes the electro-optical device according to the above described aspects of the invention.

According to the electronic apparatus of the aspect of the invention, because the electronic apparatus is provided with the above described electro-optical device of the aspect of the invention, it is possible to implement various electronic apparatuses that are able to perform high-quality display, such as a projection display device, a cellular phone, a personal organizer, a word processor, a viewfinder-type or a direct-view-type video tape recorder, a workstation, a video telephone, a point-of-sales terminal, or a touch panel. In addition, as the electronic apparatus according to the aspect of the invention, it is possible to, for example, implement an electrophoretic device, or the like, such as an electronic paper.

The function and other advantages of the aspects of the invention will become apparent from the embodiments described below.

### BRIEF DESCRIPTION OF THE DRAWINGS

The invention will be described with reference to the accompanying drawings, wherein like numbers reference like elements.

FIG. 1 is a plan view of an electro-optical device according to an embodiment when viewed from an opposite substrate side.

FIG. 2 is a cross-sectional view that is taken along the line II-II in FIG. 1.

FIG. 3 is a block diagram that shows the circuitry of main portions of the electro-optical device according to the present embodiment.

FIG. 4 is an equivalent circuit diagram of various elements, wirings, and the like, provided in a plurality of pixels that are formed in a matrix and that constitute an image display area of the electro-optical device according to the present embodiment.

FIG. 5 is a first timing chart of various signals when the electro-optical device according to the present embodiment is operated.

FIG. 6 is a second timing chart of various signals when the electro-optical device according to the present embodiment is operated.

FIG. 7 is a timing chart that shows variations over time of the electric potential of a data line and the electric potential of a pixel electrode when the electro-optical device according to the present embodiment is operated together with a sampling signal and a compensation signal.

FIG. 8 is a timing chart according to a comparative example to FIG. 7.

FIG. 9 is a block diagram that shows the circuitry of main portions of the electro-optical device according to an alternative example of the present embodiment.

FIG. 10 is a timing chart that shows variations over time of the electric potential of a data line and the electric potential of a pixel electrode when the electro-optical device according to the alternative example of the present embodiment is operated together with a sampling signal and a compensation signal.

FIG. 11 is a cross-sectional view that shows the configuration of a liquid crystal projector according to one embodiment of an electronic apparatus according to the aspects of the invention.

### DESCRIPTION OF EXEMPLARY EMBODIMENTS

Hereinafter, an embodiment of an electro-optical device and an embodiment of an electronic apparatus according to the aspects of the invention will be described with reference to the accompanying drawings.

### 1: Electro-Optical Device

### 1-1: General Configuration of Electro-Optical Device

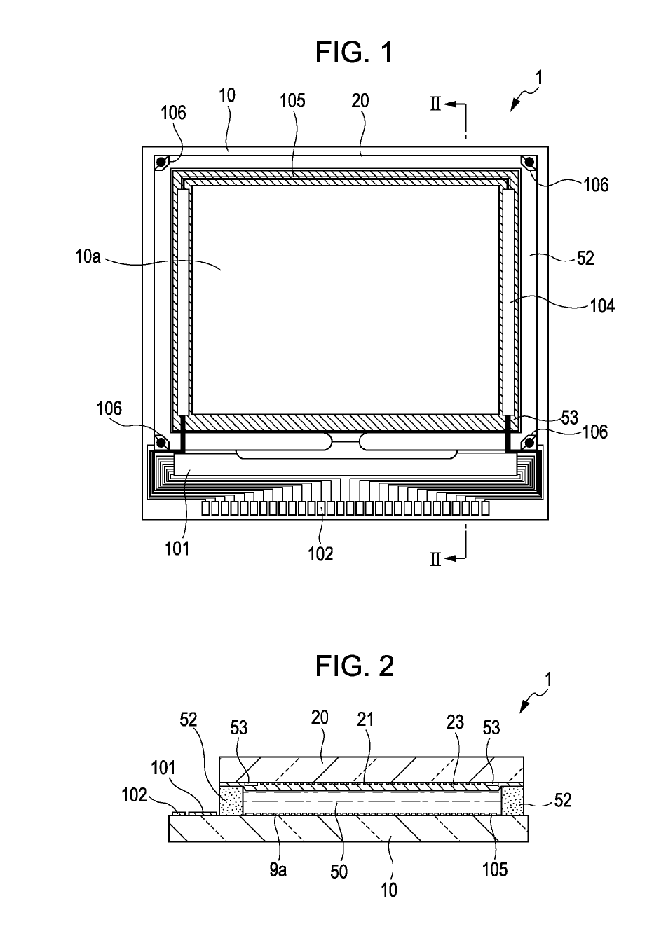

First, the general configuration of a liquid crystal device according to the present embodiment will be described with reference to FIG. 1 and FIG. 2. FIG. 1 is a plan view of the liquid crystal device when viewed from an opposite substrate side. FIG. 2 is a cross-sectional view that is taken along the line II-II in FIG. 1.

As shown in FIG. 1 and FIG. 2, the liquid crystal device 1 includes a TFT array substrate 10 and an opposite substrate 20 that are arranged so as to face each other. A liquid crystal layer 50 is sealed between the TFT array substrate 10 and the opposite substrate 20. The TFT array substrate 10 and the opposite substrate 20 are adhered to each other by a seal material 52 that is provided in a seal area located around an image display area 10a. The image display area 10a is a typical example of “display area ” according to the aspects of the invention. The seal material 52 is, for example, made of ultraviolet curing resin, thermosetting resin, or the like, for adhering both the substrates. In a manufacturing process, the seal material 52 is applied on the TFT array substrate 10 and then cured by means of ultraviolet irradiation, heating, or the like. In the seal material 52, gap materials 56, such as glass fibers or glass beads, are dispersed in order to form a gap (that is, inter-substrate gap), having a predetermined value, between the TFT array substrate 10 and the opposite substrate 20. In parallel to the inside of the seal area in which the seal material 52 is arranged, a window-frame-shaped light shielding film 53, having a light shielding property, that defines a window frame area of the image display area 10a is provided on the side of the opposite substrate 20. However, part or all of the window-frame-shaped light shielding film 53 may be provided on the side of the TFT array substrate 10 as an internal light shielding film.

In the peripheral area located around the image display area 10a on the TFT array substrate 10, a data line driving circuit 101, external circuit connection terminals 102 and a sample hold circuit (not shown) are provided along one side of the TFT array substrate 10. Scanning line driving circuits 104 are provided along two sides, adjacent to the one side so as to be covered with the window-frame-shaped light shielding film 53. Moreover, in order to connect the two scanning line driving circuits 104 provided on both sides of the image display area 10a, a plurality of wirings 105 are provided along the remaining one side of the TFT array substrate 10 so as to be covered with the window-frame-shaped light shielding film 53. In addition, between the TFT array substrate 10 and the opposite substrate 20, conductive terminals 106 for ensuring electrical continuity between the substrates are arranged.

As shown in FIG. 2, a plurality of pixel electrodes 9a are formed on the pixel switching TFTs, various wirings, and the like, on the TFT array substrate 10. The plurality of pixel electrodes 9a are provided at positions corresponding to intersections of a plurality of scanning lines and a plurality of data lines, which will be described later, in the image display area 10a. In addition, an alignment layer is formed on the pixel electrodes 9a. On the other hand, in the image display area 10a on the opposite substrate 20, an opposite electrode 21 that faces the plurality of pixel electrodes 9a via the liquid crystal layer 50 is formed. That is, by applying a voltage to each of the plurality of pixel electrodes 9a, a liquid crystal holding capacitor is formed between each pixel electrode 9a and the opposite electrode 21. A grid-like or striped light shielding film 23 is formed on the opposite electrode 21, and an alignment layer is further formed thereon. The liquid crystal layer 50 is, for example, formed of liquid crystal that is mixed with a single or multiple types of nematic liquid crystal. The liquid crystal layer 50 is made into a predetermined aligned state between a pair of these alignment layers.

Although not described in the drawing, in addition to the data line driving circuit 101 and the scanning line driving circuits 104, a check circuit for checking quality, defects, or the like, of the liquid crystal device during manufacturing or upon shipment, or the like, may be formed on the TFT array substrate 10. In addition, for example, a polarizing film, a retardation film, a polarizer, or the like, is arranged in a predetermined orientation respectively on a side of the opposite substrate 20, from which projection light enters and on a side of the TFT array substrate 10, from which outgoing light exits according to an operation mode, such as a twisted nematic (TN) mode, a super TN (STN) mode, or a double-STN (D-STN) mode, and a normally white mode or a normally black mode.

### 1-2: Configuration of Electrical Connection of Electro-Optical Device

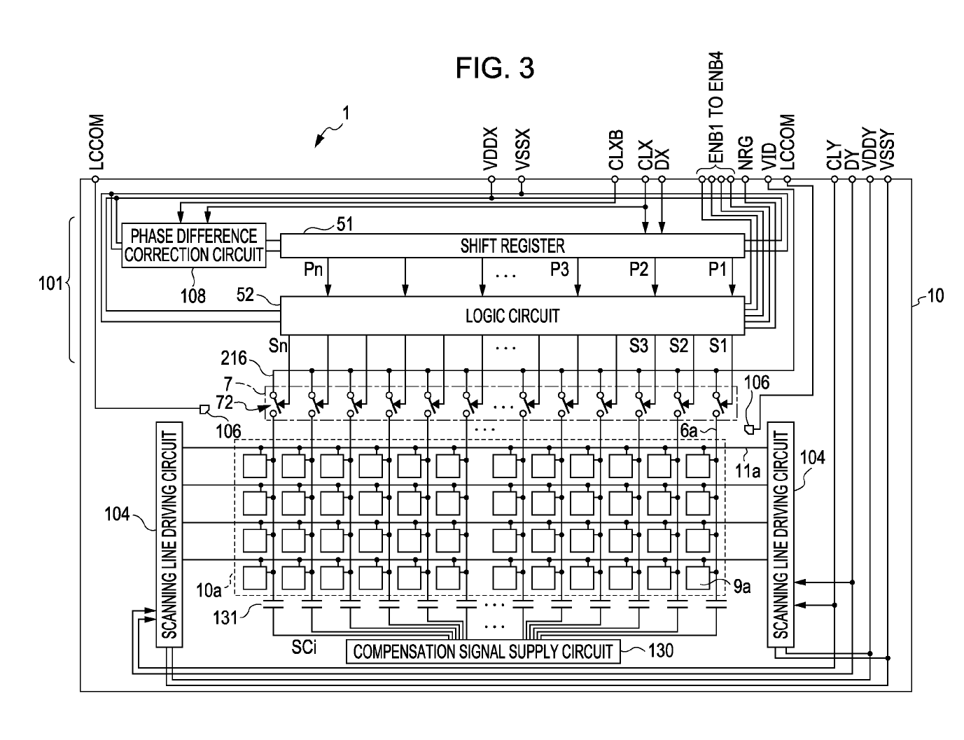

Next, the major circuitry of the liquid crystal device 1 will be described with reference to FIG. 3. Here, FIG. 3 is a block diagram that shows the circuitry of main portions of the liquid crystal device 1.

As shown in FIG. 3, the liquid crystal device 1 includes the plurality of pixel electrodes 9a, the plurality of scanning lines 11a, the plurality of data lines 6a, the scanning line driving circuits 104, the data line driving circuit 101, a sample hold circuit 7, capacitive elements 131, each of which may be regarded as an example of a “capacitive device” according to the aspects of the invention, and a compensation signal supply circuit 130, which may be regarded as an example of a “compensation signal supply device” according to the aspects of the invention.

The liquid crystal device 1 is formed so that the TFT array substrate 10 and the opposite substrate 20 (not shown in the drawing), which are, for example, formed of quartz substrate, glass substrate or silicon substrate, are arranged so as to face each other via a liquid crystal layer. The liquid crystal device 1 controls voltages applied to the pixel electrodes 9a that are defined and arranged in the image display area 10a, and modulates an electric field applied to the liquid crystal layer in each pixel. By so doing, the amount of light transmitted between the substrates is controlled, and grayshade of an image is performed.

Note that the liquid crystal device 1 employs an inversion driving method in which the voltage of an image signal VID supplied from an image signal supply circuit, which is an external circuit provided outside of the liquid crystal device 1, is inverted to positive polarity or negative polarity with respect to a predetermined reference electric potential, more specifically, a common electric potential LCCOM, and the polarity-inverted image signal VID is sequentially supplied to each pixel portion.

The plurality of pixel electrodes 9a that are arranged in a matrix and the plurality of scanning lines 11a and the plurality of data lines 6a that are arranged so as to intersect with each other are formed in the image display area 10a of the TFT array substrate 10, and the pixel portions that correspond to pixels are thus formed. Although not shown in the drawing, between each pixel electrode 9a and a corresponding one of the data lines 6a, a pixel switching TFT that is caused to enter a conductive state or non-conductive state in accordance with a scanning signal supplied through the scanning line 11a and a holding capacitor for maintaining a voltage applied to the pixel electrode 9a are formed. Driving circuits, such as the data line driving circuit 101, are formed in the peripheral area around the image display area 10a.

The data line driving circuit 101 includes a shift register 51, a logic circuit 52 and a phase difference correction circuit 108.

The shift register 51 is configured to sequentially output transmission signals Pi (i=1, . . . , n) from stages on the basis of an X-side clock signal CLX (and its inverted signal CLXB) of a predetermined period and a shift register start signal DX, which are input into the data line driving circuit 101. When the liquid crystal device 1 is operated, the shift register 51 is supplied with a power supply voltage VDDX and a power supply voltage VSSX that is lower in electric potential than the power supply voltage VDDX, and transistors that constitute the shift register 51 are driven. More specifically, the power supply voltage VDDX is supplied to the drains of the transistors that constitute the shift register 51, and the power supply voltage VSSX is supplied to the sources of the transistors that constitute the shift register 51. Note that the power supply voltages VSSX and VSSY are lower in electric potential than the power supply voltages VDDX and VDDY.

The logic circuit 52 includes a pulse width limiting device, and is driven by the power supply voltages VDDX and VSSX. The logic circuit 52 shapes the transmission signals Pi, which are sequentially output from the shift register 51, on the basis of enable signals ENB1 to ENB4 of which deformation of the signal is reduced in accordance with an NRG signal, and finally outputs a sampling circuit driving signal Si on the basis of the shaped transmission signal Pi.

The phase difference correction circuit 108 includes a bistable circuit and is driven by the power supply voltages VDDX and VSSX. The phase difference correction circuit 108, when a difference in phase between the inverted clock signal CLXB and the clock signal CLX occurs, corrects the difference in phase between these signals.

The sample hold circuit 7 includes a plurality of sampling switches 72, each of which may be regarded as a “sampling switch” according to the aspects of the invention. Each of the sampling switches 72 is electrically connected to one end of a corresponding one of the data lines 6a. The sample hold circuit 7 samples an image signal VID, which is supplied through an image signal line 216, in accordance with a sampling signal Si, and supplies the sampled image signal VID to the data line 6a.

The plurality of capacitive elements 131 are electrically connected to the other ends of the data lines 6a, and may be regarded together with a compensation signal supply circuit 130 as an example of a “compensation device ” according to the aspects of the invention. Each of the plurality of capacitive elements 131 is electrically connected to the compensation signal supply circuit 130, and applies a voltage to the corresponding data line 6a in accordance with a compensation signal SCi supplied from the compensation signal supply circuit 130 at a predetermined timing to thereby compensate for a decrease in electric potential, which occurs in the corresponding data line 6a in accordance with operation of the sampling switch 72.

Note that in the present embodiment, the case in which a single image signal VID is supplied through the single image signal line 216 is exemplified; instead, a plurality of image signals that are phase-developed through serial-parallel conversion may be simultaneously supplied. When parallel image signals that are obtained through conversion from a serial image signal are simultaneously supplied, image signals may be input to the data lines 6a by a group of the plurality of data lines 6a. This can reduce the driving frequency.

The scanning line driving circuits 104 are configured to sequentially output scanning signals Gi (i=1, . . . , n) from stages on the basis of a Y-side clock signal CLY of a predetermined period and a shift register start signal DY, which are input to the scanning line driving circuits 104, and are driven by the power supply voltages VDDY and VSSY.

### 1-3: Circuitry of Pixel Portions

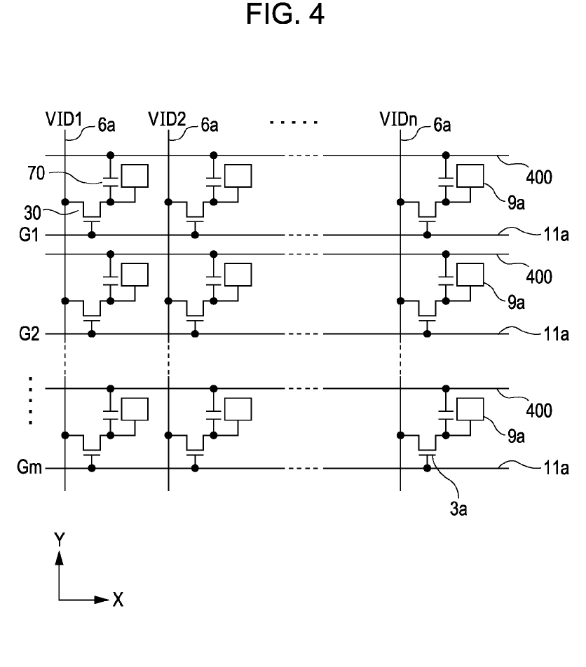

Next, the circuitry of the image display area 10a of the liquid crystal device 1 will be described with reference to FIG. 4 in detail. FIG. 4 is an equivalent circuit diagram of various elements, wirings, and the like, provided in a plurality of pixels that are formed in a matrix and that constitute the image display area of the liquid crystal device 1.

In each of the plurality of pixels that are formed in a matrix and that constitute the image display area 10a of the liquid crystal device 1, the pixel electrode 9a and a TFT 30 for performing switching control of the pixel electrode 9a are formed, and the data line 6a to which an image signal is supplied is electrically connected to the source of the TFT 30. Image signals VID1, VID2, . . . , and VIDn to be written to the data lines 6a may be supplied line-sequentially in this order or may be supplied by the group formed of a plurality of adjacent data lines 6a.

The scanning lines 11a are electrically connected to the gates of the TFTs 30, and scanning signals Gj (j=1, 2, . . . , and m) are applied line-sequentially to the scanning lines 11a at a predetermined timing in this order in a pulse-like manner. Each of the pixel electrodes 9a is electrically connected to the drain of the TFT 30. By closing the switch of the corresponding TFT 30, which is a switching element, only for a certain period of time, the image signals VID1, VID2, . . . , and VIDn supplied through the data lines 6a are written to the pixel electrodes 9a at a predetermined timing.

The image signals VID1, VID2, . . . , and VIDn of predetermined levels, written to the liquid crystals through the pixel electrodes 9a, are held for a certain period of time between the pixel electrodes 9a and the opposite electrode formed on the opposite substrate. The liquid crystal modulates light to enable grayshade as alignment and/or order of molecular association is changed by an applied voltage level. In the case of a normally white mode, a transmittance ratio to incident light is reduced in accordance with a voltage applied by pixels. In the case of a normally black mode, a transmittance ratio to incident light is increased in accordance with a voltage applied by pixels. As a whole, light having a contrast corresponding to image signals is emitted from the liquid crystal device.

Here, in order to prevent the leakage of image signals being held, holding capacitors 70 are added so as to be in parallel with the liquid crystal capacitors that are formed between the corresponding pixel electrodes 9a and the opposite electrode. One of electrodes of the holding capacitor 70 is in parallel with the pixel electrode 9a and is connected to the drain of the TFT 30, and the other electrode is electrically connected to a capacitor line 400 of which the electric potential is fixed so as to be applied with a constant electric potential.

### 1-4: Method of Driving Liquid Crystal Device

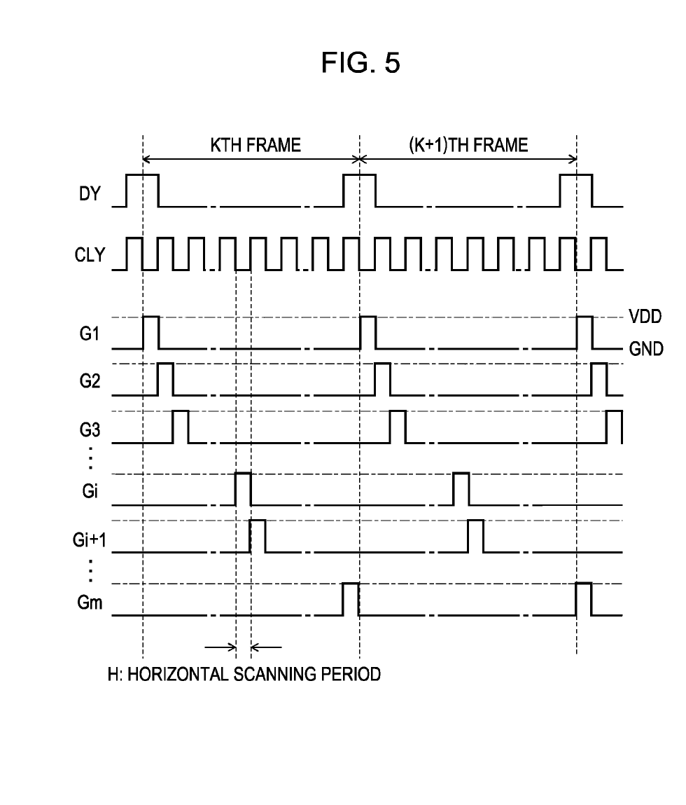

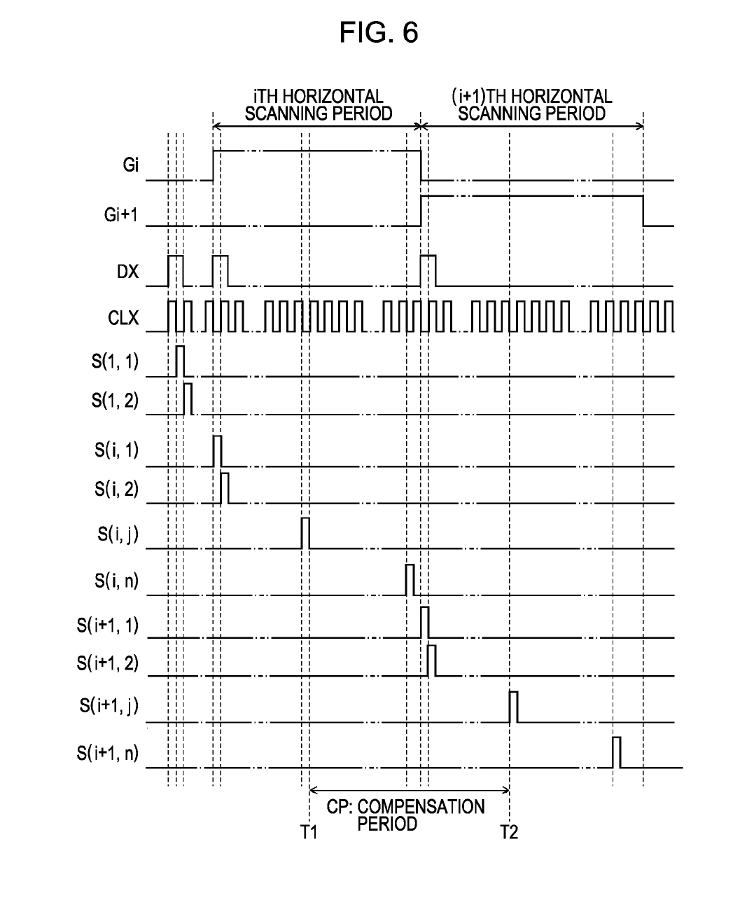

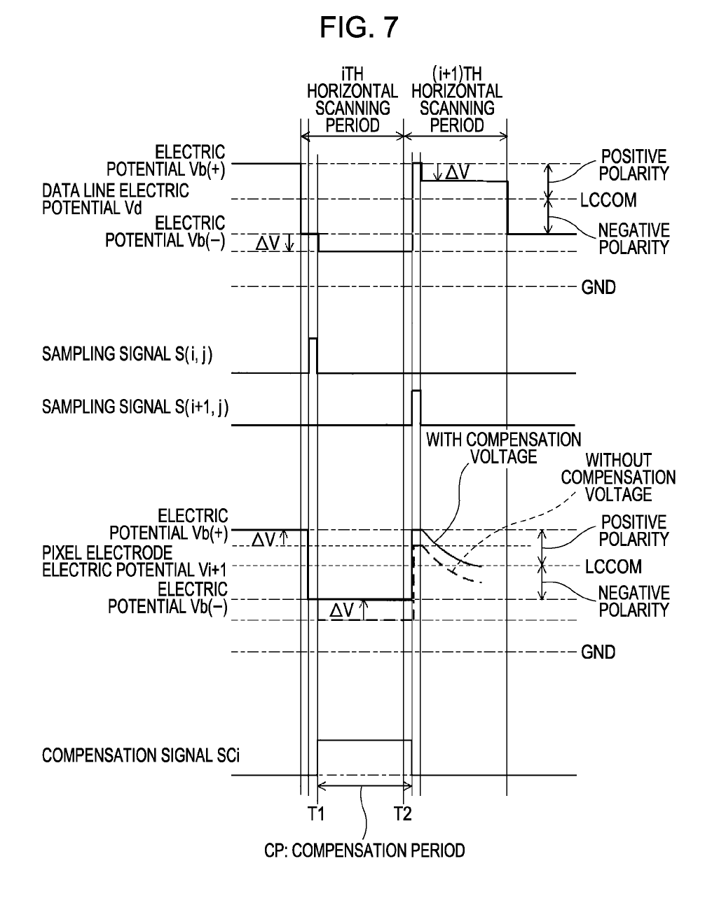

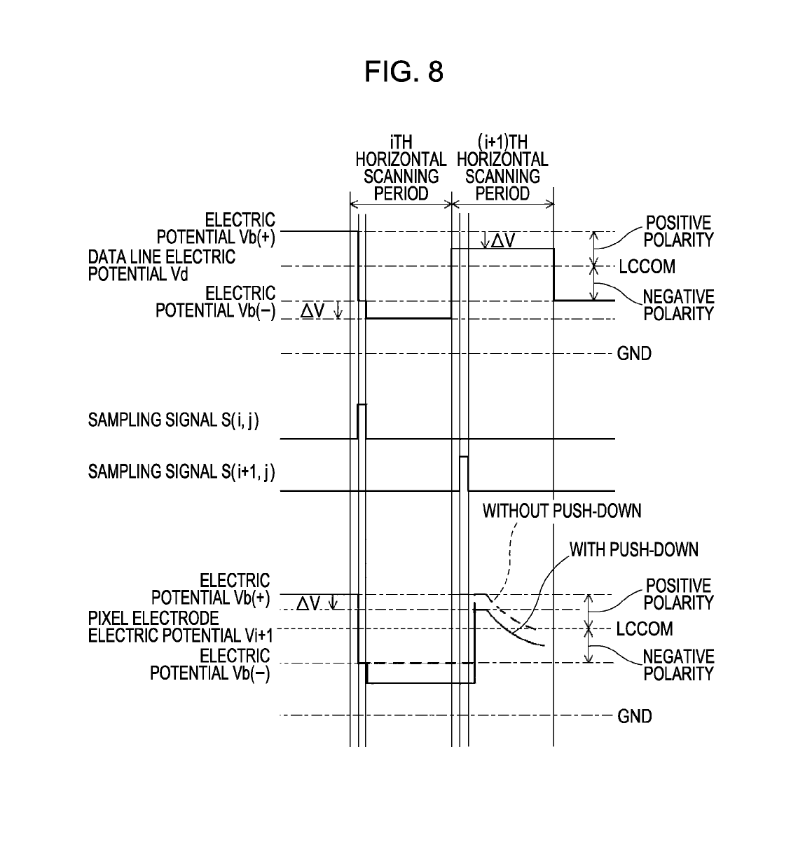

Next, the method of driving the liquid crystal device 1 will be described with reference to FIG. 5 to FIG. 8. FIG. 5 and FIG. 6 are timing charts of various signals when the liquid crystal device 1 is operated. FIG. 7 is a timing chart that shows variations over time of the electric potential of a data line and the electric potential of a pixel electrode when the liquid crystal device 1 is operated together with a sampling signal and a compensation signal. FIG. 8 is a timing chart according to a comparative example to FIG. 7. Note that hereinafter, the method of driving the liquid crystal device 1 will be described specifically focusing on, the ith horizontal scanning period during which the scanning signal Gi is supplied to the ith scanning line 11a and the (i+1)th horizontal scanning period during which the scanning signal Gi+1 is supplied to the (i+1)th scanning line 11a among the horizontal scanning periods during which scanning signals are sequentially supplied to the plurality of scanning lines 11a during one frame. That is, hereinafter, the ith horizontal scanning period may be regarded as an example of a “first horizontal scanning period according to the aspects of the invention, and the (i+1)th horizontal scanning period may be regarded as an example of a “second horizontal scanning period” according to the aspects of the invention.

As shown in FIG. 5, a Kth frame and a (K+1)th frame are started in accordance with the input start signal DY, and the scanning signals G1, G2, . . . , Gi, . . . , and Gm are sequentially supplied to the scanning lines 11a at the timing at which the Y-side clock signal CLY rises. The period during which the electric potential of the scanning signal Gi is maintained at a high level is a horizontal scanning period H during which an image signal can be written to the ith row pixel portions.

Next, as shown in FIG. 6, during the Kth frame, the shift register start signal DX is supplied to the data line driving circuit 101 prior to the start of the first horizontal scanning period, and the X-side clock signal CLX is sequentially supplied to the data line driving circuit 101. A sampling signal S(i, j) for switching the sampling switch 72 from an off state to an on state is supplied to each sampling switch 72 in accordance with the X-side clock signal CLX.

Here, the sampling signal S(i, j) represents a sampling signal that is supplied to the sampling switch 72 corresponding to the jth data line 6a from among the plurality of data lines 6a during the ith horizontal scanning period. More specifically, for example, the sampling signal that is supplied to the sampling switch 72 corresponding to the first data line 6a during the first horizontal scanning period is represented as a sampling signal S(1, 1).

In the present embodiment, as will be described later, a decrease in electric potential of the jth data line 6a is compensated over a compensation period CP from a timing T1, at which the sampling signal S(i, j) supplied to the sampling switch 72 corresponding to the jth data line 6a rises during the ith horizontal scanning period and may be regarded as an example of a “first timing” according to the aspects of the invention, until the sampling signal S(i+1, j) is supplied to the sampling switch 72 corresponding to the jth data line 6a during the (i+1)th horizontal scanning period. More specifically, the capacitive element 131 applies a compensation voltage to the jth data line 6a to raise the voltage of that data line 6a so as to compensate for a decrease in electric potential of the jth data line 6a, which occurs at the timing T1 due to the capacitance between the gate and source of the sampling switch 72, which is a semiconductor device such as TFT, over the compensation period CP.

Next, the method of driving the liquid crystal device 1 will be described in more detail with reference to FIG. 7 and FIG. 8.

The case in which a decrease in electric potential of the jth data line 6a is not compensated over the compensation period CP will be described with reference to FIG. 8.

As shown in FIG. 8, during the ith horizontal scanning period and the (i+l)th horizontal scanning period, the scanning signals Gi and Gi+1 are sequentially supplied respectively to the scanning lines 11a that are located adjacent to each other along the data line 6a. During the ith horizontal scanning period, an image signal VID is supplied to the jth data line 6a through the sampling switch 72 that has been switched to an on state in accordance with the sampling signal S(i, j).

Among the plurality of pixel portions that constitute the ith row and the plurality of pixel portions that constitute the (i+1)th row, two pixel portions that are electrically connected to the jth data line 6a are electrically connected to the same data line 6a. When push-down has occurred in the jth data line 6a in accordance with operation of the sampling switch 72 that is electrically connected to the jth data line 6a at the timing T1, even if a positive polarity image signal VID is supplied to the jth data line 6a during the (i+1)th horizontal scanning period, the jth data line 6a will be set to an electric potential that is lower than the electric potential Vb(+) of the positive polarity image signal VID by a push-down voltage ΔV.

More specifically, when the electric potential Vd of the data line 6a is decreased by the push-down voltage ΔV in a state where the image signal VID having an electric potential Vb(−) that is lower than the common electric potential LCCOM during the ith horizontal scanning period, even when the image signal VID having a positive polarity electric potential Vb(+) is supplied to the data line 6a during the (i+1)th horizontal scanning period, the electric potential Vd of the data line 6a will be set to an electric potential that is lower than the originally desired electric potential Vb(+) by the push-down voltage ΔV when a sampling signal S(i+1, j) is supplied to the sampling switch 72 corresponding to the jth data line 6a at the timing T2.

In this way, when the image signal VID supplied through the data line 6a that is set to an electric potential lower by the push-down voltage ΔV is supplied through the TFT 30 to the pixel electrode 9a, a pixel electrode electric potential Vi+1 that would be set during the (i+1)th horizontal scanning period will be an electric potential that is lower than the originally desired electric potential Vb(+). This decreases the display quality of the liquid crystal device 1. Thus, in order to set the pixel electrode electric potential Vi+1 to the originally desired positive polarity electric potential Vb(+) during the (i+1)th horizontal scanning period, it is conceivable that the electric potential of the positive polarity image signal VID is set to be higher so as to cancel the push-down voltage ΔV. However, to reset the electric potential of the image signal VID to be higher by the push-down voltage ΔV, it leads to a complex circuitry of the image signal supply circuit.

In addition, in the present embodiment, because the inversion driving method is employed, the push-down voltage ΔV causes asymmetric pixel electrode electric potentials Vi+1 that would be set to the positive polarity and negative polarity electric potentials with respect to the common electric potential LCCOM. Because of asymmetric pixel electrode electric potentials Vi+1, a voltage applied to the liquid crystal between the opposite electrode 21 and the pixel electrode 9a differs between the period during which the positive polarity image signal VID is written to the pixel electrode 9a and the period during which the negative polarity image signal VID is written to the pixel electrode 9a and, therefore, a direct-current voltage component is applied to the liquid crystal due to the difference in applied voltage. Thus, because of the push-down voltage ΔV, the liquid crystal degrades due to a direct-current voltage component and, as a result, reliability of the liquid crystal device 1 is decreased.

To eliminate the asymmetric voltages being applied, it is conceivable that the common electric potential LCCOM is shifted to a lower electric potential side; however, as in the case where the electric potential of the positive polarity image signal VID is shifted to a high electric potential side, it leads to a complex circuitry of a power supply circuit for supplying the common electric potential LCCOM to the liquid crystal device 1.

Then, as shown in FIG. 7, in the liquid crystal device 1, the compensation signal supply circuit 130 and the capacitive elements 131 compensate for a decrease in electric potential of each data line 6a, which occurs due to operation of the corresponding sampling switch 72 at the timing T1, over the compensation period CP from the timing T1 to the timing T2.

More specifically, the compensation signal supply circuit 130 supplies the compensation signal SCi to each capacitive element 131 over the compensation period CP. Each of the capacitive elements 131 applies a compensation voltage to the data line 6a, to which the capacitive element 131 is electrically connected, in accordance with the supply of the compensation signal SCi. This compensation voltage is a voltage that is equivalent to the push-down voltage ΔV or larger than the push-down voltage ΔV. Owing to the compensation voltage, the electric potential of the jth data line 6a, which is lowered by the push-down voltage ΔV, is raised at least by the push-down voltage ΔV. Thus, owing to the compensation signal supply circuit 130 and the capacitive elements 131, a decrease in electric potential of the jth data line 6a, which occurs due to push-down, is compensated, and it is possible to set the pixel electrode electric potential Vi+1 to the originally desired electric potential Vb(+) of the image signal VID without raising the electric potential of the positive polarity image signal VID or shifting the electric potential of the common electric potential LCCOM to a lower electric potential side. Thus, it is possible to reduce defective display due to the push-down voltage ΔV.

In addition, owing to the compensation signal supply circuit 130 and the capacitive elements 131, asymmetric voltages applied to the liquid crystal are eliminated, so that it is possible to suppress degradation of the liquid crystal due to a direct-current voltage component being applied to the liquid crystal. Thus, it is possible to improve reliability of the liquid crystal device 1.

Note that in the present embodiment, the method of driving the liquid crystal device 1 is described by taking the continuous ith horizontal scanning period and (i+1)th horizontal scanning period over time, for example; however, a “compensation voltage” according to the aspects of the invention only needs to be supplied continuously over the continuous horizontal scanning periods over time, that is, more specifically, over a period from the falling timing to rising timing of a sampling signal supplied to the same data line 6a in the successive horizontal scanning periods.

In addition, in the liquid crystal device 1, by supplying the compensation signal SCi to the capacitive element 131, it is possible to apply the data line 6a with a compensation voltage that compensates for a decrease in electric potential of that data line 6a using electric charge that is generated in the capacitive element 131 on the basis of the capacitance of the capacitive element 131 and the voltage of the compensation signal SCi. Thus, the combination of the capacitance of the capacitive element 131 and the voltage of the compensation signal SCi may be set separately and specifically in accordance with the capacitance between the gate and source of the sampling switch 72. For example, when the voltage of the compensation signal SCi cannot be set separately in accordance with a decrease in electric potential of the data line 6a, or when the voltage of the compensation signal SCi cannot be increased, by setting the capacitance of the capacitive element, such as a capacitor, to an appropriate capacitance in advance, it is possible to compensate for a decrease in electric potential of the data line 6a without separately changing the voltage of the compensation signal SCi.

Particularly, in the present embodiment, the capacitance of the capacitive element 131 is desirably equivalent to the capacitance between the gate and source of the sampling switch 72. According to the above capacitive element 131, even without changing the magnitude of the voltage of the compensation signal SCi or setting the magnitude of the voltage to an appropriate value, by setting the voltage of the compensation signal SCi to have the same amplitude as the sampling signal S(i, j), it is possible to apply a voltage, which is equivalent to a decrease in electric potential of the data line 6a, from the capacitive element 131 to that data line 6a.

In addition, in the liquid crystal device 1, a voltage larger than or equal to the compensation voltage that compensates for a decrease in electric potential of the data line 6a, which corresponds to the push-down voltage ΔV, may be applied to the jth data line 6a over the compensation period CP by the compensation signal supply circuit 130 and the capacitive element 131.

According to the above compensation voltage, when the TFT 30 is an n-channel TFT, it is possible to reduce leakage current that leaks from the TFT 30. More specifically, for example, because the source of the TFT 30 is electrically connected to the data line 6a, shifting the electric potential of the data line 6a to a high electric potential side makes the voltage between the gate and source of the TFT 30 to be smaller than the threshold voltage of the TFT 30, thus making it possible to reduce occurrence of leakage current.

In addition, because the liquid crystal device 1 employs an inversion driving method, it is not necessary to set the electric potential of a positive polarity image signal VID to a higher electric potential side in advance so as to compensate for a decrease in the pixel electrode electric potential Vi+1 of the pixel electrode 9a to which the image signal VID is supplied in response to a decrease in electric potential of the data line 6a. Thus, it is possible to suppress setting of the source electric potential of the sampling switch 72 to be higher in accordance with the electric potential of the positive polarity image signal VID and, therefore, it is possible to set the source electric potential to be lower at the time of operation of the sampling switch 72. By so doing, at the time of operation of the sampling switch 72, by applying the sampling signal S(i, j) having a relatively low electric potential to the gate of the sampling switch 72 as compared with the case in which the data line 6a is not applied with a voltage larger than or equal to the compensation voltage, it is possible to apply a voltage, which is larger than or equal to the threshold voltage of the sampling switch 72, between the source and gate of the sampling switch, so that it is possible to improve the operating characteristic of the sampling switch 72.

Note that according to the liquid crystal device 1, because the push-down voltage ΔV can be compensated by a compensation voltage, even when, for example, push-down voltages that occur in the data lines 6a due to characteristic variations of the sampling switches 72 vary, the varied push-down voltages ΔV can be compensated by compensation voltages.

### ALTERNATIVE EXAMPLE

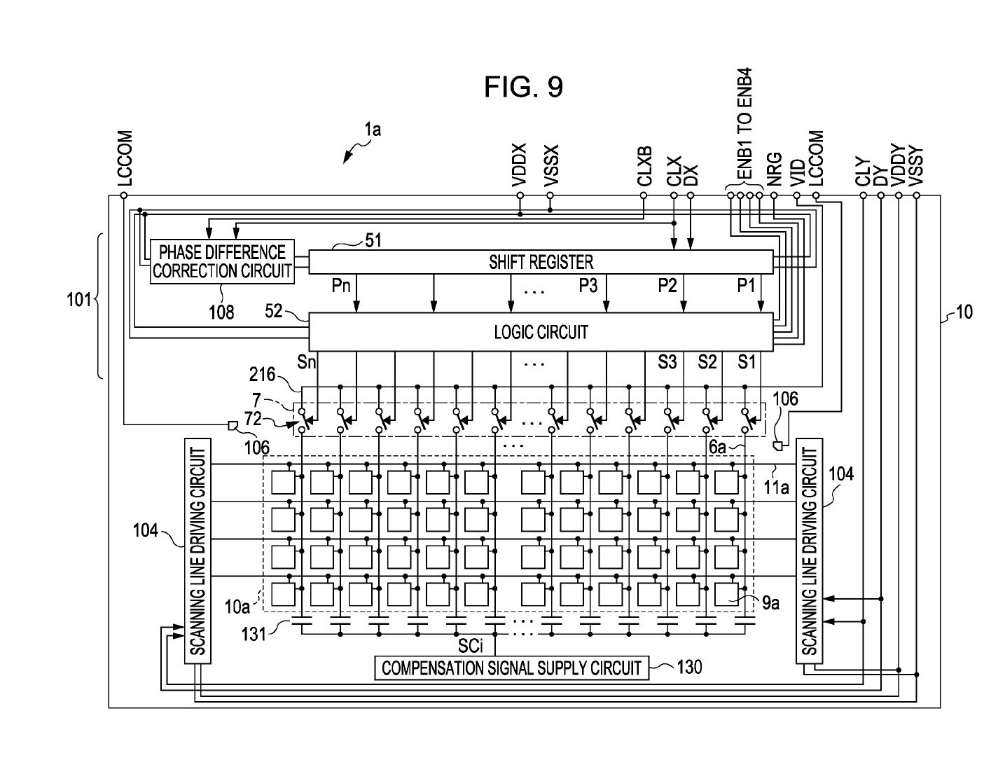

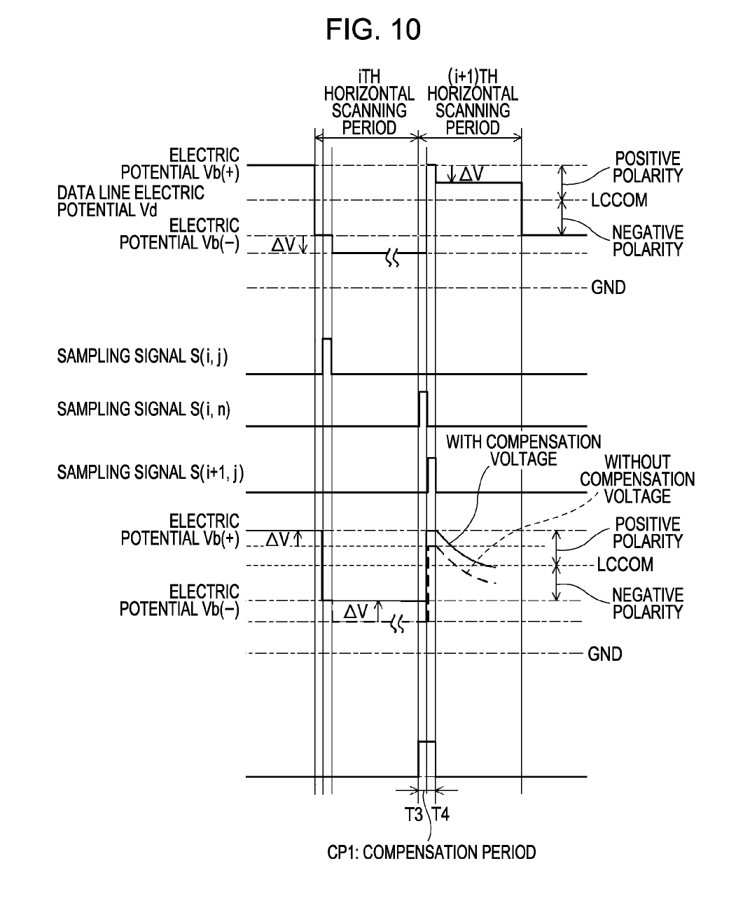

Next, an electro-optical device according to an alternative example of the present embodiment will be described with reference to FIG. 9 and FIG. 10. FIG. 9 is a block diagram that shows the circuitry of main portions of the electro-optical device according to the present example. FIG. 10 is a timing chart that shows variations over time of the electric potential of a data line and the electric potential of a pixel electrode when the electro-optical device according to the alternative example of the present embodiment is operated together with a sampling signal and a compensation signal. Note that, in the following description, like reference numerals are assigned to like components to those of the liquid crystal device 1, and detailed description thereof is omitted.

As shown in FIG. 9, the liquid crystal device la according to the present example differs from the above described liquid crystal device 1 in that a common compensation signal SCi is supplied from the compensation signal supply circuit 130 to the plurality of capacitive elements 131.

As shown in FIG. 10, according to the liquid crystal device la, it is possible to compensate at a time for a decrease in electric potential, which occurs at the time of operation of the sampling switches 72 in the data lines 6a that are electrically connected to the pixel electrodes 9a arranged in the same row.

More specifically, a compensation period CP1 is a period from a timing T3 at which a sampling signal S(i, n) is input to a timing T4 at which a sampling signal (i+1, j) supplied to the sampling switch corresponding to the jth data line 6a falls at the time of next scanning. The above compensation period CP1 allows compensation at a time for decreases in electric potentials of the data lines 6a, which occur at the time of operation of the sampling switches.

### 2: Electronic Apparatus

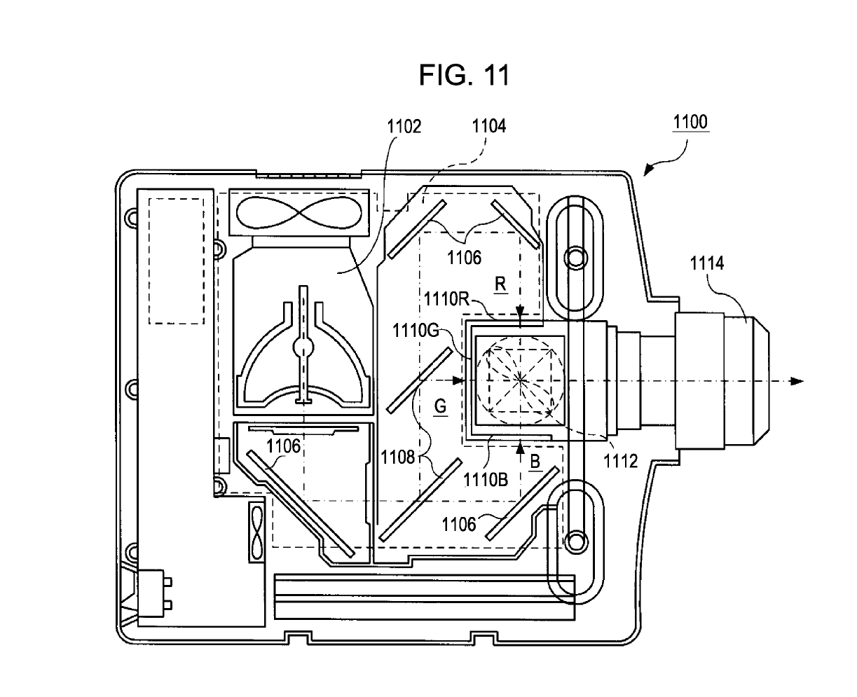

Next, an electronic apparatus that employs the above described liquid crystal device will be described with reference to FIG. 11. FIG. 9 is a plan view that shows the configuration of a liquid crystal projector, which is an example of an electronic apparatus according to the aspects of the invention.

As shown in FIG. 11, a projector 1100 installs therein a lamp unit 1102 formed of a white light source, such as a halogen lamp. Light projected from the lamp unit 1102 is split into three primary colors, that is, RGB, by four mirrors 1106 and two dichroic mirrors 1108, which are arranged in a light guide 1104 and then enter liquid crystal panels 1110R, 1110B and 1110G, which are light valves corresponding to the primary colors.

The configurations of the liquid crystal panels 1110R, 1110B and 1110G have configurations equivalent to the above described liquid crystal device, and are respectively driven by primary color signals of R, G, and B, which are supplied from an image signal processing circuit. Then, light modulated by these liquid crystal panels enters a dichroic prism 1112 from the three directions. In this dichroic prism 1112, R light and B light are refracted at a right angle while, on the other hand, G light goes straight. Thus, by composing images corresponding to the respective colors, a color image is projected onto a screen, or the like, through a projection lens 1114.

Here, focusing on display images by the liquid crystal panels 1110R, 1110B and 1110G, the display image by the liquid crystal panel 1110G needs to be mirror reversed horizontally relative to the display images of the liquid crystal panels 1110R, 1110B. Note that, because rays of light corresponding to the primary colors of R, G, and B enter the liquid crystal panels 1110R, 1110B and 1110G by the dichroic mirrors 1108, no color filter needs to be provided.

According to the above projector 1100, it is possible to reduce defective display, such as horizontal crosstalk that occurs in the image display areas of the respective liquid crystal panels 1110R, 1110B and 1110G when the projector 1100 is operated, thus making it possible to perform high-quality image display.

The entire disclosure of Japanese Patent Application No. 2007-281391, filed Oct. 30, 2007 is expressly incorporated by reference herein.

What is claimed is:

1. An electro-optical device comprising:
a substrate;
scanning lines;
data lines;
pixel electrodes that are provided in a display area on the substrate at positions corresponding to intersections of the scanning lines and the data lines that intersect with each other;
sampling switches, one of the sampling switches being electrically connected to one of the data lines, the one of the sampling switches sampling an image signal upon being supplied with a sampling signal, and supplying the sampled image signal to the one of the data lines, the one of the sampling switches being switched from a conductive state to a non-conductive state at a first timing during a first horizontal scanning period and being switched from the non-conductive state to the conductive state at a second timing during a second horizontal scanning period that comes following the first horizontal scanning period; and
a compensation device that applies a voltage to the one of the data lines over a compensation period from the first timing to a the second timing in order to compensate for a decrease in electric potential of the one of the data lines that occurs at the first time.

2. The electro-optical device according to claim 1, wherein the compensation device applies the voltage, which is larger than or equal to a compensation voltage that compensates for a decrease in the electric potential, to each data line over the corresponding compensation period.

3. The electro-optical device according to claim 1, wherein
each sampling switch is electrically connected to one end of the corresponding data line, and wherein
the compensation device includes a capacitive device that is electrically connected to the other end, opposite to the one end, of a corresponding one of the data lines; and a compensation signal supply device that supplies a compensation signal to each capacitive device over the compensation period so that the capacitive device is able to compensate for a decrease in the electric potential.

4. The electro-optical device according to claim 3, wherein the compensation signal has an amplitude that is equivalent to that of the sampling signal.

5. An electronic apparatus comprising the electro-optical device according to claim 1.
